(19) United States
(12) Patent Application Publication
(10) Pub. No.: US 2007/0159838 A1
(43) Pub. Date: Jul. 12, 2007

(54) Multi-filament auto head lamp illumination apparatus

(76) Inventor: Joseph W. Ladd JR., Utica, NY (US)

Correspondence Address: DAVID GIGLIO, ESQ, 231 ELIZABETH STREET, UTICA, NY, 13501, US

(21) Appl. No.: 11/329,701

(22) Filed: Jan. 12, 2006

(51) Int. Cl. F21V 1/00

(52) U.S. Cl. 362/509

(57) ABSTRACT

There is provided an non-automobile multi-filament auto head lamp illumination assembly for use with a conventional multi-filament automobile head lamp in which at least one filament of the head lamp is unspent. An assembly lamp receptacle accommodates the automobile head lamp. A power converter converts single phase one hundred and twenty volts of alternating current to twelve volts DC or AC. A filament selector selects the unspent filament to which the twelve volts is provided, thus producing illumination.

### FIELD OF THE INVENTION

The present invention relates generally to the field of multi-filament illumination apparatus and, more particularly, to an apparatus that implements an auto head lamp having one spent filament and selects the unspent filament to provide illumination.

### BACKGROUND OF THE INVENTION

Auto head lamps typically include a low beam filament for normal night driving and a high beam filament of much brighter intensity for darker night driving. Each of the filaments are connected to a respective electronic connector. The driver selects the low beam or high beam filament via switching circuitry near the driving position.

When either of the low beam or high beam filaments becomes spent, the auto lamp must be discarded as it is hazardous driving without either the low or high beam lighting. Thus, the auto head lamp is discarded even though it still has a useful filament, structurally sound connectors, housing and lens cap.

One attempt to extend the useful life of an auto head lamp was described in U.S. Pat. No. 3,414,762 to Wyzykowski. Wyzykowski describes a non-conventional auto head lamp in which an extra filament and connector are incapable of being accessed and illuminated by the automobile circuitry. When the auto use of this non-conventional auto head lamp expires, the lamp is brought in-house and now mates with a standard light receptacle to access the extra filament. The problem with this invention is that the head lamp is more expensive to produce because of the extra connector and required circuitry.

One attempt to provide a multi-filament standard in-house light bulb in which a second filament is automatically selected upon the expiration of the first filament is provided in U.S. Pat. No. 4,580,079 to Koo. However, this special bulb is expensive to manufacture and is designed solely for standard in-house lamp receptacles.

### OBJECTS AND SUMMARY OF THE PRESENT INVENTION

It is an object of the present invention to improve the environment and reduce consumer spending on light bulbs by giving auto head lamps a second life as an in-house illumination source.

It is another object of the present invention to economically improve in-house lighting by using auto head lamps having one spent and one unspent filament to provide illumination.

It is yet another object of the present invention to provide an illumination apparatus which provides for selection of an unspent filament of a used auto head lamp.

It is yet a further object of the present invention to conserve the earth's resources by gaining a second use of an auto headlamp, such that the housing and other components are not discarded because of only one spent filament.

It is still another object of the present invention to improve the economic efficiency associated with everyday lighting needs by providing a second life for an auto head lamp after its use in the automobile becomes antiquated because of one spent filament.

It a feature of the present invention to provide an illumination apparatus which utilizes an auto head lamp having a spent filament to provide direct or indirect lighting that is easily adjusted for height and direction.

These and other objects and features are provide in accordance with the present invention in which there is provided an illumination assembly for receiving a conventional multi-filament automobile headlamp. The illumination assembly includes a lamp receptacle which receives a standard automobile headlamp. A power receptacle is plugged into a standard single phase one hundred and twenty volt alternating current circuit. A power converter or optional active component power supply converts the voltage from 120 VAC to twelve volts DC or AC and delivers up to 70 watts to the headlamp. A filament selector selects one of a high beam or low beam filament to which the twelve volts is provided across thereby producing illumination.

A switch allows the user to turn the illumination assembly on and off. A telescoping support post allows adjustment of the auto head lamp. The lamp receptacle swivels about the support post to change illumination direction. A concave reflector superposed over an obverse surface of the head lamp provides indirect lighting.

### BRIEF DESCRIPTION OF THE DRAWINGS

The present invention will be understood and appreciated more fully from the following detailed description taken in conjunction with the drawings in which:

FIG. 1 is a front elevation view of the multi-filament lamp illumination assembly in accordance with a preferred embodiment;

FIG. 2 is an electrical schematic diagram depicting the functional electronics in accordance with the present invention of the present invention;

FIG. 3 is front elevation view of a multi-filament auto head lamp;

FIG. 4 is a front elevation view of an adjustable support post in an extended position in accordance the preferred embodiment of FIG. 1;

FIG. 5 is a front elevation view of the adjustable support post of FIG. 4 in a retracted position; and

FIG. 6 is a front perspective view of an alternative embodiment of a multi-filament lamp illumination assembly in accordance with the present invention.

### DETAILED DESCRIPTION OF THE PRESENT INVENTION

The present invention shall now be described in accordance with a preferred embodiment in light of the Figures. It should be apparent that the within described fastening and rotating parts are described in accordance with the Figures and that one skilled in the art may find various fastening and rotating parts to accomplish the features described herein.

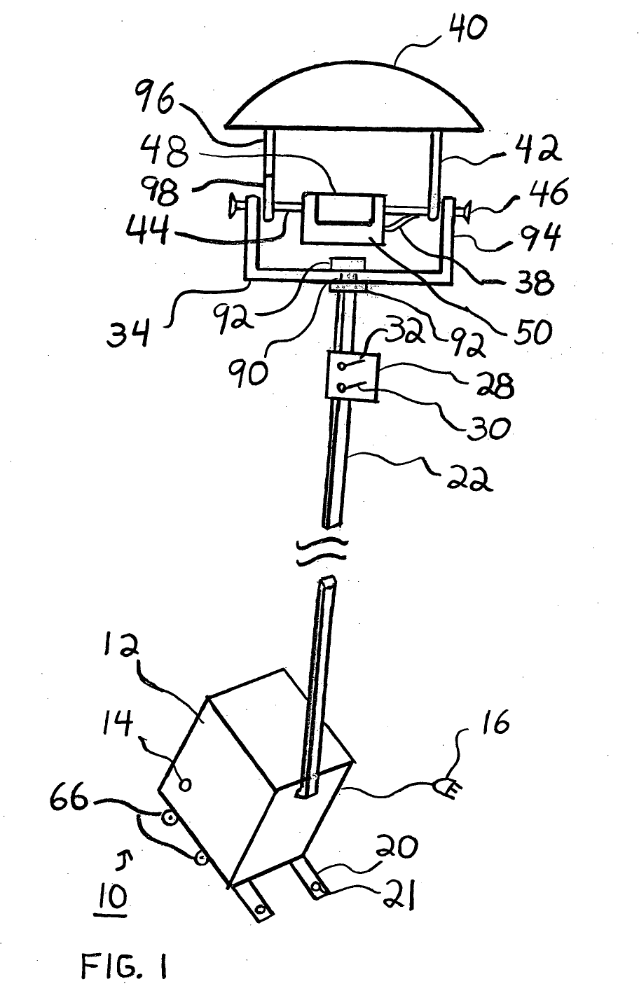

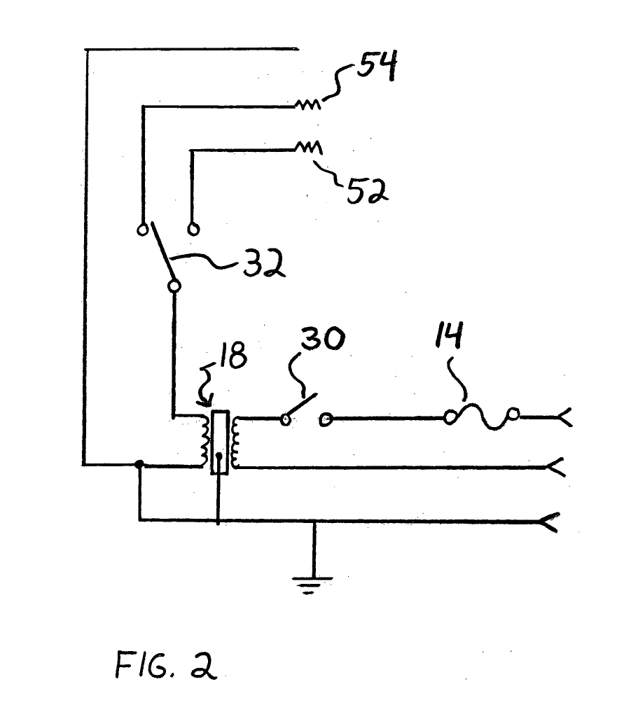

Looking at FIG. 1, there is shown a multi-filament lamp illumination assembly 10 in which a base unit 12 includes a power cord 16, typically 12-14 gauge wire, for connecting into a standard 120 volt alternating current circuit via a standard house plug (not shown). A 10:1 power transformer 18, shown in FIG. 2, mounted inside of the base unit 12 converts the 120 volts into a 12 volt output.

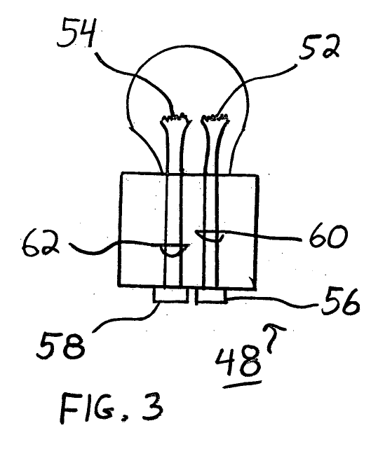

A fuse 14, depicted in both FIG. 2 and 3, opens to prevent damage to the multi-filament lamp illumination assembly 10 or to personnel when there is a short in the circuit 13, depicted in FIG. 2.

A multi-filament lamp, hereinafter an auto head lamp 48, electronically mates with a lamp receptacle 50. The auto head lamp 48, depicted in FIG. 3, includes a high beam filament 52 and a low beam filament 54. The high beam filament 52 and low beam filament 54 become illuminated when 12 volts are provided across their lead wires 60 and 62, respectively, via the high beam and low beam connector 56 and 58 respectively.

Alternate power supply mechanisms are also suitable to accomplish the power reduction to provide twelve volts to the auto head lamp 48. For example, an active power supply converter module, which utilizes transistors, is also suitable to convert the 120 volts to 12 volts. Further, a battery could also be implemented to provide twelve volts of direct current to the auto head lamp 48.

The multi-filament lamp illumination assembly 10 includes a switch box 28 in which both a power switch 30 and filament selector 32 are mounted. Alternatively, the power switch 30 may be installed in the base unit 12 before the transformer 18 as depicted in FIG. 2.

The power switch 30 interrupts and connects the 12 volts to the lamp receptacle 50. The filament selector 32 selects one of the two filaments 52 or 54 for which electrical power shall be provided.

When one of the filaments of the auto head lamp 48 becomes spent, the auto head lamp 48 no longer becomes useful in an automobile and must be discarded. Rather than discard the auto head lamp 48, the present invention allows the auto head lamp 48 a second life as an in-house workshop light or the like.

Thus, the user places the auto head lamp 48, of which one filament is spent, into the lamp receptacle 50. The user then connects the power to the lamp receptacle 50 via the power switch 30. If the auto head lamp 48 illuminates, then the correct filament is selected. If the auto head lamp 48 does not illuminate, then the user simply selects the other filament via the filament switch 32, which causes light to emanate thought the lens of the auto head lamp 48. Therefore, the auto head lamp 48 now has a second life as a shop light or cellar light.

The base unit 12 includes a pair of brackets 20 such that the illumination assembly 10 is mounted to a wall or floor via openings 21 in the brackets. Alternatively, a set of casters 66 allows the illumination assembly 10 to become mobile so that it can be moved into a useful position or out of the way.

For various applications it is preferable to have different illumination intensity, direct or indirect lighting, etc. The present invention allows the user to control the direction and illumination intensity of the light.

An adjustable support post 22 extends from the base unit 12 to a U-pedestal 34. As will be shown, an assembly power cord 38, typically comprising 16 gauge wiring, is routed through the support post 22, outside of the support post 22 or through the support post 22 for some stretches and outside of the support post 22 for other stretches.

The height of the illumination assembly 10 is adjusted via the adjustable support post 22. Alternatively, the support post 22 may be of a fixed dimension.

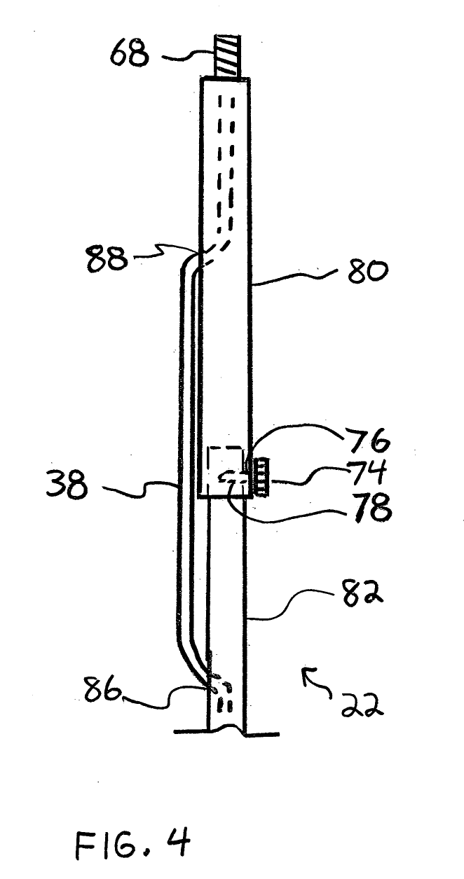

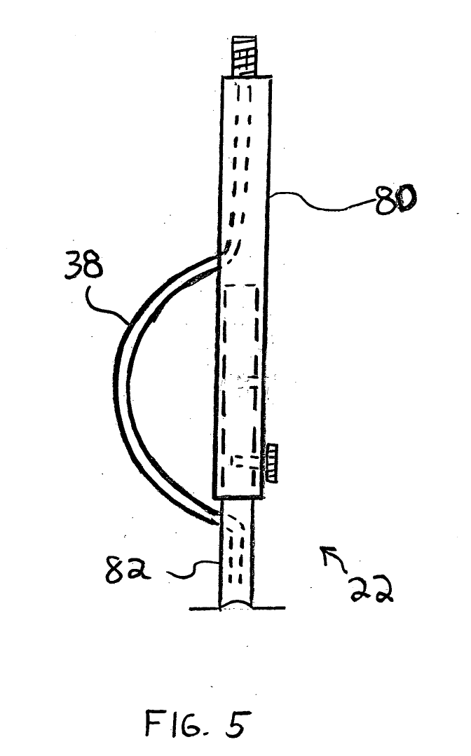

Turning now to FIGS. 4 and 5, the support post 22 comprises an upper post member 80 and a lower post member 82. As shown in FIGS. 4 and 5 the lower post member 82 telescopes inside of the upper post member 80. Alternatively, the upper post member 80 could telescope inside of the lower post member 82 to provide the same height adjustment effect.

A lock pin 74 fits through an opening 76 in the upper post member 80 and through one of various openings 78 in the lower post member 82. Thus, the height of the illumination assembly 10 is simply adjusted by removing the lock pin 74 and sliding the upper post member 80 up or down and re-inserting the lock pin 74.

As shown in FIGS. 4 and 5, the assembly power cord 38 is routed from the base unit 12 through the hollow lower post member 82 and then out through a cable opening 86 in the lower post member 82. The assembly power cord 38 is then routed back inside of a cable opening 88 in the upper post member 80 and then through the hollow upper post member 80 to the lamp receptacle 50. Rubber grommets (not shown) installed in the cable openings 86 and 88 prevent damage to the assembly power cord 38.

It is shown that when the adjustable support post 22 is adjusted for maximum height, depicted in FIG. 4, the assembly power cord 38 bears an essentially straight run between the openings 86 and 88. When the adjustable support post 22 is set on a minimum height as shown in FIG. 5, the assembly power cord 38 forms a looped portion between the openings 86 and 88.

The upper support post 80 terminates with a hollow threaded member 68 which threads through a female threaded receptacle 90 in the U-bracket 34. A pair of locknuts 92 are disposed on both sides of the U-bracket 34, thereby allowing for swiveling of the U-bracket 34 for rotational adjustment of the light beam about the support post 22. To rotate the U-bracket 34, the locknuts 92 are loosened, the U-bracket 34 rotated to the desired position, and then the locknuts 92 are re-tightened.

The lamp receptacle 50 suspends via a connecting rod 44 through side members 94 of the U-bracket 34. Wing nuts 46 disposed on the connecting rod 44 allows the user to adjust the rotation of the lamp receptacle 50 relative the axis of the connecting rod 44.

A concave reflector 40 mounts to the connecting rod 44 using reflector support posts 42. The concave reflector 40 reflects the intensity of the auto lamp 48, thereby providing indirect lighting to the room or to a target area. A tightening screw (not shown) tightens the support posts 42 to the connecting rod 44 so that the concave reflector 40 rotates with the lamp receptacle 50.

In some situations it is desirable to have direct lighting on a target area, such as when working inside of an automobile engine area. In this type of situation. The tightening screws are loosened and the concave reflector 40 is rotated out of the way so that the auto lamp 48 focuses directly inside of the engine area.

The reflector support posts 42 further include upper and lower telescoping members 96 and 98 which allows the user to adjust the height of the concave reflector 42 to the focal length of the light beam for maximum reflection.

Thus, an auto head lamp 48 having one spent filament is inserted into the lamp receptacle 50 of the multi-filament lamp illumination assembly 10. The multi-filament lamp illumination assembly 10 is either mounted for semi-permanent installation via the brackets 20, or is rolled into location using the casters 66.

The power cord is plugged into a 120 volt receptacle and the power switch is rotated to the ON position. If the auto head lamp 48 is not illuminated, then the filament switch 32 must be rotated to the other filament position.

The adjustable support post 22 is adjusted for height position, while the auto head lamp 48 is rotated for illumination direction. The concave reflector 40 is adjusted to match the focal length of the light emanating from the auto head lamp 48. If direct lighting is desired rather than indirect lighting, then the concave reflector 40 is rotated out of the way.

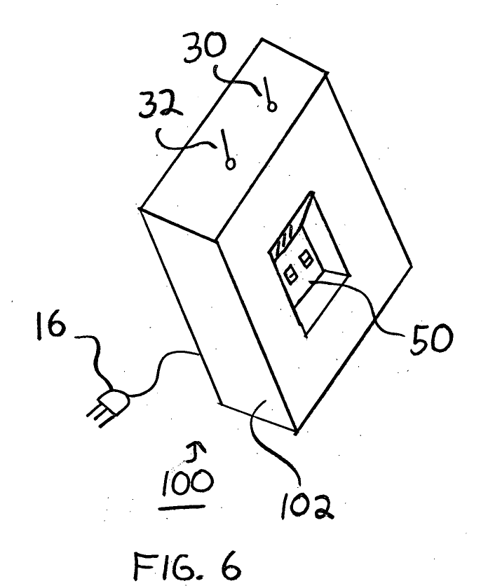

Turning now to FIG. 6, there is depicted an alternative embodiment of the present invention in which there is provided a multi-filament lamp illumination assembly 100 in which an auto lamp (not depicted in FIG. 6) is connected in the lamp receptacle 50. The multi-filament illumination assembly 100 includes a free standing housing 102, a power cord 16, power switch 30 and a filament selector 32. A step down transformer (not depicted) is mounted inside of the housing 102.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. An illumination assembly for receiving a conventional multi-filament automobile headlamp, said assembly comprising:
a lamp receptacle means for receiving said conventional multi-filament automobile head lamp, in which said multi-filament automobile head lamp receptacle includes a low beam and a high beam filament;
power receiving means for accessing and receiving one hundred and twenty volts from a standard power receptacle;
power converting means for converting said one hundred and twenty volts to twelve volts; and
filament selecting means for providing said twelve volts across either of said high or low beam filaments of said automobile head lamp.

2. The illumination assembly of claim 1, further including switching means electronically disposed between said power receiving means and said filament selecting means which allows the twelve volts of alternating current to pass across said filament selecting means.

3. The illumination assembly of claim 1, further including height adjustment means for adjusting the height of the auto head lamp.

4. The illumination assembly of claim 3, wherein said height adjustment means further includes a pair of telescoping support posts.

5. The illumination assembly of claim 1, wherein said lamp receptacle is disposed adjacent to an upper end of a support post, and further including a swiveling means for swiveling said lamp receptacle radially about a longitudinal axis of said support post.

6. The illumination assembly of claim 1, further including a concave reflector superposed over said auto head lamp for providing indirect lighting.

7. The illumination assembly of claim 1, further including focal length adjustment means for adjusting the distance between the concave reflector relative to the auto head lamp.

8. The illumination assembly of claim 1, wherein said lamp receptacle is disposed adjacent to a distal end of a support post and further including rotating means for rotating the lamp receptacle radially about an axis which is orthogonal to a longitudinal axis of said support post.

9. The illumination assembly of claim 1, wherein said concave reflector includes a concave reflector inner surface and wherein said auto head lamp includes an obverse illumination surface, and further including rotating means for rotating said concave reflector inner surface away from said obverse surface.

10. A method for providing illumination from a conventional auto head lamp in which the conventional auto head lamp includes one spent filament and at least one unspent filament by using said conventional auto head lamp within a non-automobile illumination assembly, said method comprising:
connecting said conventional auto head lamp to an auto head lamp receptacle of said non-automobile illumination assembly;
connecting said non-automobile illumination assembly to a one hundred and twenty volt source;
converting the voltage to twelve volts;
selecting said at least one unspent filament; and
providing said twelve volts across said at least one unspent filament to produce illumination.

11. The method of claim 10, further including adjusting the height of said auto head lamp.

12. The method of claim 10, wherein said lamp receptacle is disposed adjacent to an upper end of a support post and further including the step of swiveling the auto head lamp receptacle radially about a longitudinal axis of said support post.

13. The method of claim 10, further including the step of providing a concave reflector over an obverse surface of said auto head lamp, such that indirect illumination is provided.

14. The method of claim 13, further including the step of distancing the concave reflector relative to the auto head lamp to accommodate a focal length associated with the illumination provided by the at least one unspent filament.

15. The method of claim 10, wherein said lamp receptacle is disposed adjacent to an upper end of a support post and further including the step of rotating said auto head lamp receptacle radially about an axis which is orthogonal to a longitudinal axis of said support post.

16. The method of claim 10, further including the step of rotating the concave reflector away from the produced illumination.

17. An illumination assembly comprising:
a lamp receptacle means for receiving a conventional multi-filament automobile head lamp;
a conventional multi-filament automobile head lamp receptacle having a low beam and a high beam filament integral with said lamp receptacle means;
power means which provide twelve volts to said lamp receptacle means; and
filament selecting means for providing said twelve volts across either of said high or low beam filaments of said automobile head lamp.

18. The illumination assembly of claim 17, where said power means further includes power receiving means for accessing and receiving one hundred and twenty volts from a standard power receptacle and power converting means for converting said one hundred and twenty volts to twelve volts.
